(19) United States
(12) Patent Application Publication
(10) Pub. No.: US 2024/0284144 A1
(43) Pub. Date: Aug. 22, 2024

(54) PRIORITIZING MULTIPLE LOCALIZATION TECHNOLOGIES

(71) Applicant: QUALCOMM Incorporated, San Diego, CA (US)

(72) Inventors: Gang DING, San Diego, CA (US); Harleen GILL, Los Altos, CA (US); Mark Aaron LINDNER, Broomfield, CO (US); Joel MORRIN, North Reading, MA (US); Grant MARSHALL, Campbell, CA (US)

(21) Appl. No.: 18/171,218

(22) Filed: Feb. 17, 2023

(51) Int. Cl. H04W 4/029; G01C 21/34

(52) U.S. Cl. CPC H04W 4/029; G01C 21/3492

(57) ABSTRACT

In some implementations, a mobile device may receive, from a server, a set of priority lists for localization of the mobile device, where the set of priority lists comprises, for each context of a plurality of contexts, a corresponding prioritized list of localization methods for the mobile device to use, during a journey, for a respective context. The mobile device may determine an applicable context from the plurality of contexts based on a course location of the mobile device along the journey. The mobile device may perform localization method in accordance with a priority list, from the set of priority lists, corresponding to the applicable context.

### BACKGROUND

### 1. Field of Disclosure

The present disclosure relates generally to the field of wireless communications, and more specifically to the position determination of a mobile electronic device capable of wireless communications.

### 2. Description of Related Art

Wireless mobile devices such as mobile phones and asset tracking devices often engage in wireless communications along a route of travel. For example, asset tracking devices may periodically send reports of their estimated location and other information to a remote monitoring device (e.g., server) via a wireless communication network. Wireless mobile devices may use any of a variety of different techniques to determine their estimated location, and different techniques may have different accuracies and power requirements. Further, accuracy and power requirements may vary depending on device type, application, and/or other factors.

### BRIEF SUMMARY

An example method of localization of a mobile device, according to this disclosure, may comprise receiving, with the mobile device from a server, a set of priority lists for localization of the mobile device, wherein the set of priority lists comprises, for each context of a plurality of contexts, a corresponding prioritized list of localization methods for the mobile device to use, during a journey, for a respective context. The method also may comprise determining, with the mobile device, an applicable context from the plurality of contexts based on a course location of the mobile device along the journey. The method also may comprise performing, with the mobile device, a localization method in accordance with a priority list, from the set of priority lists, corresponding to the applicable context.

An example method of localization of a mobile device, according to this disclosure, may comprise receiving, at a server, information regarding a journey for the mobile device. The method also may comprise determining, with the server, a set of priority lists for localization of the mobile device based at least in part on the information regarding the journey, wherein the set of priority lists comprises, for each context of a plurality of contexts, a corresponding prioritized list of localization methods for the mobile device to use during the journey for a respective context. The method also may comprise sending the set of priority lists from the server to the mobile device.

An example mobile device comprising: a transceiver, a memory, one or more processors communicatively coupled with the transceiver and the memory, wherein the one or more processors are configured to receive, via the transceiver from a server, a set of priority lists for localization of the mobile device, wherein the set of priority lists comprises, for each context of a plurality of contexts, a corresponding prioritized list of localization methods for the mobile device to use, during a journey, for a respective context. The one or more processors further may be configured to determine an applicable context from the plurality of contexts based on a course location of the mobile device along the journey. The one or more processors further may be configured to perform a localization method in accordance with a priority list, from the set of priority lists, corresponding to the applicable context.

An example server comprising: a transceiver, a memory, one or more processors communicatively coupled with the transceiver and the memory, wherein the one or more processors are configured to receive information regarding a journey for a mobile device. The one or more processors further may be configured to determine a set of priority lists for localization of the mobile device based at least in part on the information regarding the journey, wherein the set of priority lists comprises, for each context of a plurality of contexts, a corresponding prioritized list of localization methods for the mobile device to use during the journey for a respective context. The one or more processors further may be configured to send the set of priority lists from the server to the mobile device via the transceiver.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a system enabling the creation and use of route-based coverage maps, according to an embodiment.

FIG. 2 is a table illustrating certain characteristics of various localization methods.

FIG. 3 is a table comprising an example set of priority lists, according to an embodiment.

FIG. 4 is a flow diagram of example functionality that a mobile device may employ during a journey, according to an embodiment.

FIG. 5 is a call flow diagram illustrating how a mobile device may interact with cloud services to obtain and use priority lists for localization methods, according to an embodiment.

FIG. 6 is a flow diagram of a method for adjusting a priority list, according to an embodiment.

FIG. 7 is a flow diagram of a method of localization of a mobile device, according to an embodiment.

FIG. 8 is a flow diagram of another method of localization of a mobile device, according to an embodiment.

FIG. 9 is a block diagram of an embodiment of a mobile device.

FIG. 10 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. As described in more detail herein, such signals may comprise any of a variety of signal types but may not necessarily be limited to a Positioning Reference Signal (PRS) as defined in relevant wireless standards. A wireless signal used for positioning may be generically referred to herein as a reference signal (RS).

A determined location of a mobile device may be referred to herein as a “location estimate,” “estimated location,” “location,” “position,” “position estimate,” “position fix,” “estimated position,” “location fix” or “fix.” Further, unless otherwise specified, the process of determining a location may be referred to terms “localization,” “positioning,” “location determination,” “position determination,” and or the like. Such positioning may include and/or be based on timing, angular, phase, or power measurements, or a combination thereof (which may include RF sensing measurements) for the purpose of location (e.g., tracking) or sensing services.

As used herein, a location (e.g., of a mobile device) may comprise an absolute location (e.g., a latitude and longitude and possibly altitude) or a relative location (e.g., a location expressed as distances north or south, east or west and possibly above or below some other known fixed location or some other location such as a location for a mobile device at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location of a mobile device may further include an uncertainty or error indication, such as a horizontal and possibly vertical distance by which the location is expected to be in error or an indication of an area or volume (e.g., a circle or ellipse) within which the mobile device is expected to be located with some level of confidence (e.g., 95% confidence).

A wireless mobile device may be capable of determining its estimated location (performing localization) along a route of travel in any of a variety of ways. As noted, these different localization techniques may vary in accuracy, power consumption, communication overhead, processing time, or any combination thereof. Further, some localization techniques may be ineffective or less effective at certain locations. Global navigation satellite system (GNSS) positioning such as global positioning system (GPS) positioning, for example, may be unable to determine an accurate location in a tunnel or in an “urban canyon” where tall buildings and other objects obstruct the sky. The accuracy of positioning of a wireless mobile device based on a terrestrial network may be dependent on signal quality between the mobile device and other devices in the network. Thus, the most efficient localization technique for a particular device during a route of travel may depend on device type, location, and/or other factors.

Embodiments herein address these and other issues by providing a set of priority lists of localization methods for a wireless mobile device to use along a route of travel. The set of priority lists may include different lists for different contexts, where different contexts may include different accuracy levels, power consumption, estimated speed, device condition, environment condition, events, alerts, or any combination thereof. According to some embodiments, a server may be used to generate the set of priority lists, which it provided to a mobile device prior to and/or during travel. Further, the set of priority lists may be specific to the route of travel and/or mobile device type, and may leverage other information, such as weather, historical data, and so forth. According to some embodiments, a server may also provide the wireless mobile device with events associated with different contexts, to help enable the wireless mobile device to applicable context and an associated priority list of localization methods to use. The use of priority lists as described in the embodiments herein can help ensure that a wireless mobile device uses an effective localization technology and one or more waypoints along the route of travel, which can help ensure higher accuracy, lower power consumption, higher reliability, or combination thereof.

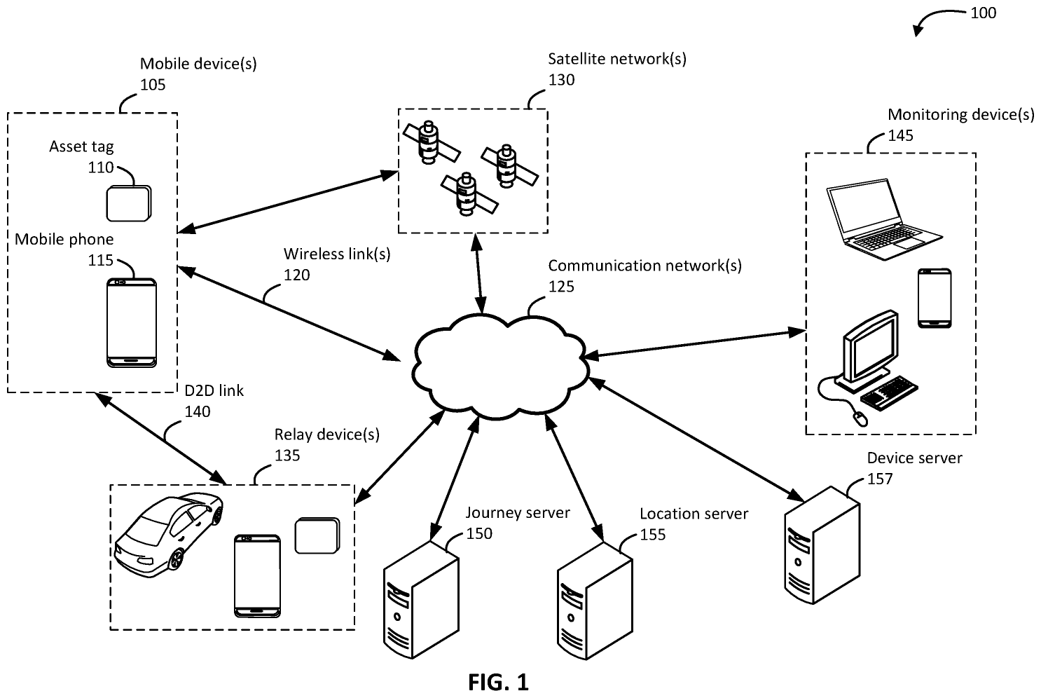

Embodiments may be implemented using any of a variety of different components. An example system is provided in FIG. 1.

FIG. 1 is a diagram of a system 100 enabling the creation and use of context-based priority lists of localization methods or wireless mobile devices, according to an embodiment. As with other figures provided herein, FIG. 1 is provided as a non-limiting example, and alternative embodiments may have additional or alternative components and/or the various components may be connected in different ways. In FIG. 1, arrows represent communication links, which may include wired and/or wireless communications that may be governed by different standards and/or protocols. It will be further understood that FIG. 1 is a simplified diagram. The various components, networks, and communication links may include additional devices that are not shown, and the number and/or type of devices shown in FIG. 1 are not intended to be exhaustive or limiting. The illustrated communication links that connect the various components in the system 100 comprise data and signaling connections which may include additional (intermediary) components, direct or indirect physical and/or wireless connections, and/or additional networks. It should be noted that FIG. 1 provides only a generalized illustration of various components, any or all of which may be utilized as appropriate, and each of which may be duplicated as necessary. Specifically, although only a certain number of components are illustrated, it will be understood that many components (e.g., hundreds, thousands, millions, etc.) may be used within the system 100. Furthermore, components may be rearranged, combined, separated, substituted, and/or omitted, depending on desired functionality.

In the system 100, mobile device(s) 105 may comprise wireless mobile devices capable of communicating via one or more wireless networks. Examples of such mobile devices 105 comprise asset tag 110 and mobile phone 115. Additional types of mobile devices 105 (not shown) may include, for example a laptop, tablet, personal data assistant (PDA), navigation device, Internet of Things (IoT) device, wearable device, In Vehicle communications System (IVS), or some other portable or moveable device with wireless communication capabilities. Depending on desired functionality, the mobile device(s) 105 may support wireless communication using one or more Radio Access Technologies (RATs) such as using GSM, CDMA, W-CDMA, Long Term Evolution (LTE), High Rate Packet Data (HRPD), IEEE 802.11 Wi-Fi®, Bluetooth, Worldwide Interoperability for Microwave Access (WiMAX™), 5G New Radio (NR), etc. The mobile device(s) 105 may also support wireless communication using a Wireless Local Area Network (WLAN) which (like the one or more RATs) may connect to other networks, such as the Internet. The use of wireless communications can enable the mobile device(s) 105 to communicate (e.g., via wireless link(s) 120) with other components of the system 100 via the communication network(s) 125.

Depending on desired functionality, the communication network(s) 125 may comprise any of a variety of wireless and/or wireline networks, including the wireless network(s) accessible by the mobile device(s) 105 via the wireless link(s) 120. The communication network(s) 125 can, for example, comprise any combination of public and/or private networks, local and/or wide-area networks, and the like. Furthermore, the communication network(s) 125 may utilize one or more wired and/or wireless communication technologies. In some embodiments, the communication network(s) 125 may comprise a cellular or other mobile network, a wireless local area network (WLAN), a wireless wide-area network (WWAN), and/or the Internet, for example. Examples of communication network(s) 125 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Communication network(s) 125 may also include more than one type of network.

According to some embodiments, the mobile device(s) 105 may be capable of communicating with the communication network(s) 125 via one or more satellite networks 130, which may also be referred to as satellites 130. According to some embodiments, satellite network(s) 130 may comprise a satellite-based communication network having satellites (also known as space vehicles (SVs)) capable of communicating with terrestrial devices, including mobile device(s) 105. Satellites in the satellite network(s) 130 may comprise, for example, a constellation of low-Earth orbit (LEO), medium-Earth orbit (MEO) and/or geostationary-Earth orbit (GEO) satellites communicatively coupled with one or more terrestrial networks (e.g., communication network(s) 125). Satellite network(s) 130 may be referred to as non-terrestrial networks (NTNs), and, according to some embodiments, satellites of the satellite network(s) 130 may functionally support and operate non-terrestrial transmission reception points (TRPs) (also known as transmit/receive points) of a WWAN network (e.g., LTE and/or NR network). Satellites 130 used for communication may be different than satellites used for GNSS positioning (which may be used by the mobile device(s) 105 as described elsewhere herein). It can be further noted that non-terrestrial communication network positioning (e.g., NTN-based positioning) may utilize other non-terrestrial vehicles in addition or as an alternative to satellites, including non-space vehicles such as high-altitude platform stations, balloons, airplanes, drones, etc.

According to some embodiments, the mobile device(s) 105 may be capable of communicating with the communication network(s) 125 via one or more relay device(s) 135. As illustrated, relay device(s) 135 may comprise mobile devices such as cars, IVSs, cell phones, asset tags, etc., which can include the same types of devices as mobile device(s) 105, or may be different. Mobile device(s) 105 may communicate with relay device(s) 135 via a device-to-device (D2D) link 140, such as Proximity Services (ProSe) or sidelink. The D2D link 140 may employ sidelink signaling and can relay communications between the mobile device(s) 105 and communication network(s) 125 via a relay device 135. That is, if a mobile device 105 is outside a wireless coverage area of the communication network(s) 125 but within wireless communication range of one or more relay device(s) 135 that are inside the wireless coverage area, the one or more relay device(s) 135 can effectively extend the wireless coverage area of the communication network(s) 125 to the mobile device 105 via the D2D link 140. In some scenarios, multiple relay devices 135 may form a communication chain such that communications between the mobile device(s) 105 and communication network(s) 125 may pass through multiple relay devices 135. In an alternative embodiment, a relay device 135 may contain base station functions (e.g., similar to a base station in the cellular network) and may be seen by a mobile device 105 as a base station of a communication network 125, in which case, relaying may occur via the relay 135 and a link 140 that uses uplink/downlink signaling instead of sidelink signaling.

Additionally or alternatively, relay device(s) 135 may be utilized to help determine the position of mobile device(s) 105 by measuring wireless signals (e.g., RS) to determine relative angles and/or distance, which can be used to determine a location estimate of mobile device(s) 105 geometrically (e.g., using multi-lateration location, multi-angulation, etc.). According to some embodiments, measurements taken by relay device(s) 135 of wireless signals transmitted by mobile device(s) 105 and/or measurements taken by mobile device(s) 105 of wireless signals transmitted by relay device(s) 135 may be used for position determination of the mobile device(s) 105 using a terrestrial network (also known as RAT-based position), such as a cellular or Wi-Fi network.

Monitoring device(s) 145 may comprise one or more devices remote from the mobile device(s) 105 with which the mobile devices 105 communicate. Monitoring device(s) 145 may be used by an individual, company, agency, other entity, or a combination thereof, to monitor and/or manage mobile device(s) 105, and may comprise one or more servers, laptops, PCs, mobile devices, specialized hardware, or the like. In an application such as asset tracking, for example, mobile device(s) 105 may comprise one or more asset tags 110 that periodically communicate their location to monitoring device(s) 145. The monitoring device(s) 145 may comprise a server that gathers this information, which may be accessible via a web portal or application, executed by a computer or mobile device, that indicates to users (e.g., via a display) the location of the one or more asset tags 110. Monitoring device(s) 145 may also gather statistical information regarding the asset tags 110 for data analysis, logistical optimization, etc.

Journey server 150 may comprise a physical and/or virtual server, accessible to various components in the system 100, that provides a service with which the mobile device(s) 105 and/or other components (e.g., location server 155) may obtain a route of travel for a particular journey of the mobile device(s) 105. In some embodiments, the journey server 150 may simply use map information to determine the route based on an origin and destination. In some embodiments, the origin and destination may be provided by the mobile device(s) 105, in which case the journey server 150 can then provide intended route for the mobile device(s) 105 to take for the journey from origin to destination. In some embodiments, the origin and destination may be provided by another device (e.g., a monitoring device 145, a vehicle transporting the mobile device(s) 105 or an associated device, etc.). In some embodiments, the journey server 150 may perform higher-level logistical management of the mobile device(s) 105, in which case it may determine the origin and destination. This may be the case, for example, if the journey server 150 manages routing for a parcel delivery service, which may optimize route determination for a fleet of vehicles. Routes may be determined based on factors such as fuel efficiency, current traffic conditions, other road conditions, weather, vehicle range and/or other capabilities, or any combination thereof. According to some embodiments, the journey server 150 may determine a route for a vehicle transporting the mobile device(s) 105, and may then provide route information to the vehicle (and/or driver) and the mobile device(s) 105. In some embodiments, a vehicle may provide the mobile device(s) 105 with route information, which the vehicle may receive from the journey server 150. In some embodiments, the journey server 150 may provide the route to the location server 155, which may then determine a set of priority lists of localization methods for mobile device(s) 105 to use on the route.

Location server 155 may comprise a physical and/or virtual server, accessible to various components in the system 100, that provides a service for determining and/or tracking the location of mobile device(s) 105. As noted, the location server 155 can use route information to determine a set of priority lists for mobile device(s) 105 to use during a journey. As described in more detail hereafter, a location server 155 may communicate the mobile device(s) 105 to update the priority lists in certain circumstances. According to some embodiments, the location server 155 may also back the location of the mobile device(s) 105. This may involve, for example, receiving periodic reports from the mobile device(s) 105 during the journey that indicate the location of the mobile device(s) 105 (e.g., as determined by the mobile device(s) 105 using the set of priority lists). According to some embodiments, the location server 155 may also coordinate positioning of the mobile device(s) 105 using terrestrial networks (e.g., cellular and/or Wi-Fi) and/or satellites (e.g., satellite networks 130).

The device server 157 may comprise a physical and/or virtual server, accessible to various components in the system 100, that provides a service for communicating with the mobile device(s) 105. For example, they set of priority lists created by the location server 155 may be provided to the device server 157, which can then configure the mobile device(s) 105 with the set of priority lists. According to some embodiments, the device server 157 may also provide an interface with which monitoring device(s) 145 may monitor the mobile device(s) 105 (e.g., by providing a web portal where application server accessible to the monitoring device(s) 145).

The prioritization of localization techniques for mobile devices to use during the course of travel (e.g., at waypoints during a journey) can be based on various characteristics of the techniques. As noted, techniques may vary in power consumption, accuracy, and other aspects. Depending on context, different techniques may be prioritized accordingly, in view of these characteristics.

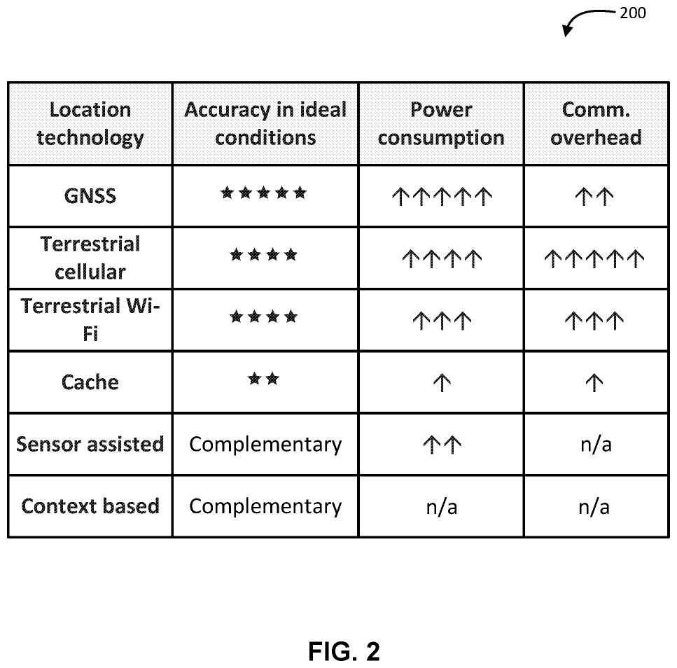

FIG. 2 is a table 200 illustrating certain characteristics of various localization methods (also referred to herein as “location technologies”). Specifically, table 200 shows ratings for accuracy, power consumption, and communication overhead (e.g., required communication between the mobile device and a server or other remote device to use the respective localization method) for GNSS positioning, terrestrial cellular positioning, terrestrial Wi-Fi positioning, cache-based positioning, sensor-assisted positioning, and context-based positioning. In table 200, the more stars indicates more accuracy, and more arrows indicates more power consumption/communication overhead.

GNSS-based positioning includes positioning based on pseudo-range and/or carrier phase measurements made at the mobile device. As shown in table 200, this requires relatively low communication overhead and can result in high accuracy, but at the cost of high power consumption.

Terrestrial cellular and terrestrial Wi-Fi positioning include positioning based on RF signals communicated between the mobile device and a cell tower (base station) or Wi-Fi AP, respectively. This may include, for example, Global Terrestrial Positioning (GTP). As previously noted, measurements of RF signals can provide information regarding the angle and/or range of a mobile device relative to one or more cell towers and/or Wi-Fi APs allowing the position of the mobile device to be calculated geometrically using the angle and/or range information along with known locations of the cell tower and/or Wi-Fi APs. As shown in table 200, these techniques can provide moderately high accuracy, but may also require moderately high power consumption and communication overhead.

The final localization methods included in the table 200 are cache, sensor-assisted, and context-based. Cache represents localization using a mobile device's own information, such as cached historical position. Sensor-assisted positioning may include dead reckoning and/or other sensor-based localization methods using data from sensors such as an inertial measurement unit (IMU), camera, or the like. Visual-based positioning, such as visual inertial odometry (VIO), may use the camera, I am you, and/or other sensors of a mobile device. Context-based positioning utilizes any contextual information around the device, such as map, weather, traffic, etc. to provide a location of the mobile device.

In addition to these considerations, reliability of different localization methods may vary for a mobile device at different points along the route of travel. GNSS positioning may deteriorate if the mobile device is indoors, terrestrial cellular or Wi-Fi-based positioning may be less accurate if the mobile device is able to communicate with only a few cell towers or APs, and so forth. Given above challenges, to perform positioning accurately over the course of the route of travel, a mobile device may need to adapt its choice of localization methods based on its current situation, or context.

It can be noted that embodiments are not limited to prioritization based on the characteristics shown in table 200, and that additional or alternative characteristics may be used for prioritization. For example, different location technologies may vary in a time to fix (e.g., a time it takes to estimate a mobile device's position). Thus, a location technology with a shorter time to fix may be prioritized over a location technology with a longer time to fix in urgent contexts. Similarly, a measurement time may be a consideration used for prioritization, wherein the location technology capable of performing a positioning-related measurement at a desired time, or within a desired duration, may be prioritized over a location technology is incapable of doing so. According to some embodiments, another consideration may be whether the location technology enables the mobile device to determine its own location, or relies on other devices (e.g., satellites, terrestrial transceiver(s), a server, etc.) do so. Such embodiments may further consider whether the mobile device needs to perform measurements and send those measurements to one or more other devices.

Further, additional aspects of the characteristics shown in table 200 may be considered for prioritization. For example, with respect to overhead, additional considerations regarding how much data may need to be sent to the mobile device, stored on the mobile device, transmitted by the mobile device, or any combination thereof, for location technologies. Further, this may be impacted by device type because different technologies we have different capabilities for communication and/or storage.

It can also be noted that embodiments are not limited to the location technologies of table 200. Some location technologies such as GNSS, terrestrial cellular, and terrestrial Wi-Fi may be broken down into specific location methods, each having its own accuracy, power consumption, etc. that may be considered for prioritization. This can include, for example, mobile device-assisted, mobile device-based, and/or network-based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real-Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. Further, for GNSS, frequency band(s) (e.g., L1, L2, L5, etc., or any combination) and/or GNSS constellation(s) (GPS, Galileo, BeiDou Navigation Satellite System (BDS), GLONASS, etc. or any combination thereof) also may be considered for prioritization. Further, as noted elsewhere herein, different location technologies may be available to different mobile devices (e.g., based on mobile device capabilities), and further may be available at different locations along a route of travel.

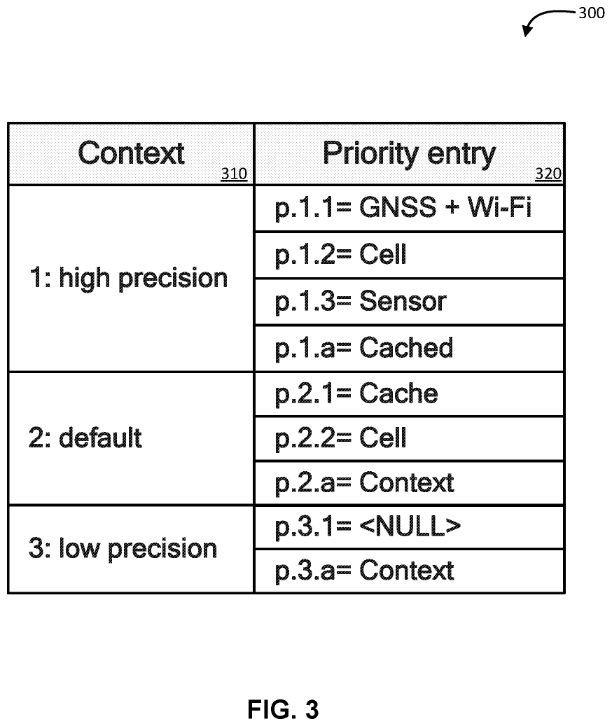

To this end, embodiments may include the generation and use of context-based priority lists, indicating a priority of localization methods a mobile device may use during a journey, based on context. FIG. 3 provides additional detail.

FIG. 3 illustrates a table 300 comprising an example set of priority lists. The left column 310 lists various contexts, and the right column 320 show priority lists corresponding to each of the listed contexts. The priority list corresponding to context 1 (high precision) includes all entries in the right column 320 beginning with “p.1,” the priority list corresponding to context 2 (default) includes all entries in the right column 320 beginning with “p.2,” and the priority list corresponding to context 3 (precision) includes all entries in the right column 320 beginning with “p.3.” The subsequent numerals indicate the priority, such that p.1.1 indicates the localization method corresponding to context 1 having the first priority, that p.1.2 indicates the localization method corresponding to context 1 having the second priority, and so on. (It can be noted that the use of numbers for different contexts and a separate numerology for priority entries is provided in table 300 for discussion purposes. In implementation, a set of priority lists may or may not include a similar numbering convention.)

A mobile device may use a set of priority lists by first determining an applicable context, then using localization methods in the priority list corresponding to the applicable context, in order of priority. If the mobile device fails to successfully determine a position estimate using the localization method(s) having the first priority in the list, it can try the localization method(s) having the second priority. If that is unsuccessful, the mobile device can try the localization method(s) having the third priority, and so on. If, at any point during the process, a localization method is successful, the mobile device can stop the process and use the estimated location from the successful localization method. Depending on desired functionality, a position estimate may be “successful” based on whether the position estimate can be determined at all, and in some embodiments, whether the position estimate as at accuracy, confidence level, or other attribute (or any combination thereof) above a threshold level.

In addition to providing a priority for localization methods, a priority list may have the flexibility to indicate additional functionality. As illustrated by entry p.1.1 in table 300, some entries may include more than one localization method. In such instances, the mobile device may use all localization methods in the priority list entry. As illustrated by entry p.3.1. In table 300, some entries may not include a localization method (e.g., a null entry). In such instances, the mobile device may not perform any localization method. Additionally or alternatively, some contexts may have localization methods that are always used (even if a null entry exists on the priority list). In the table 300, these entries are designated with the letter “a” (“p.1.a,” “p.2.a,” and “p.3.a”). A mobile device using priority list corresponding to context 2 (default), for example, performs both localization methods p.2.1 (cache) and p.2.a (context).

It can be noted that the number of contexts and/or priority entries for each context may vary from what is illustrated in FIG. 3. The entries for a priority list corresponding to a context may be based on the capabilities of the mobile device (e.g., which localization methods is capable of performing). With regard to context, although the example in table 300 includes only a single context type (accuracy) having three different contexts (high precision, default, and low precision), embodiments may use a set of priority lists that may include additional or alternative context types and/or have a higher or lower number of contexts for a particular context type. Context types may include, for example and without limitation, contexts based on accuracy, speed/latency, urgency/priority, battery level of the mobile device, approximate location along a route of travel, or the like. Some contexts may include combinations of different context types (e.g., high battery level and high accuracy), and thus a set of priority lists may include a large number of contexts and corresponding priority lists for a large number of situations that may apply to the mobile device during a journey.

Even so, according to some embodiments, embodiments may allow a mobile device to depart from using a priority list in certain circumstances. If a certain context is detected with no corresponding context in the set of priority lists, a mobile device may determine an appropriate localization method, or priority of localization methods, to use. For example, if the mobile device receives an urgent, low latency position request and there is no corresponding context in the set of priority lists, mobile device may determine an appropriate low-latency localization method to use. According to some embodiments, a mobile device may have a default priority list or set of priority lists (e.g., which may not be associated with a particular journey) that it may use in such instances.

A mobile device may determine an applicable context based on a detected event and/or input from either the device or a server. For example, a detected event comprising the battery level of the mobile device dropping below 10% may correspond with a “low battery” context, which may have its own priority list. In some embodiments, contexts may be linked to events, which may be based on instructions received from a server. For example, a set of priority lists may not have a “low battery” context, however a server may instruct a mobile device to use the priority list corresponding to the context “low precision” if mobile device detects that its battery level has dropped below 10%.

Thus, events may be directly and/or indirectly linked to different contexts. Moreover, some contexts may be applicable when a plurality of events occur (e.g., low battery detected+urgent positioning request received). According to some embodiments, contexts may be mutually exclusive such that only one context (and therefore only one priority list) is active at a given time. Additionally or alternatively, some contexts may be determined based on communication with a location server. For example, at a point during a journey, and prior to using a localization method, a mobile device may communicate with a location server to determine which is the applicable context, in the server (which may have access to live information such as weather, traffic, etc.) can provide the mobile device with an indication of which context to use, or with information for the mobile device to use for determining the applicable context.

According to some embodiments, different contexts may include or may be associated with different waypoints or segments (e.g., between two consecutive waypoints) of a journey, and thus, different priority lists may be used at different times during the journey. For example, a location server may divide a route of travel into three segments: a first segment corresponding to a first large city with many urban canyons, a second segment corresponding to ocean travel, and the third segment corresponding to a second large city with many urban canyons. In this example, GNSS may be effective during the second segment, but less effective during the first and third segments. Terrestrial cellular and Wi-Fi positioning may be inaccessible during the second segment, but may be utilized during the first and third segments. Further, during the third segment, the device's battery may be relatively low, so localization methods consuming higher power may be less desirable. With all these factors in mind, a location server may provide a mobile device with contexts comprising and/or associated with the first, second, and third segments. A mobile device may determine whether it is located in the first, second, or third segments (e.g., prior to using a priority list to perform a localization method) based on contextual information such as time, historical information, detected RF signals (e.g., base station/Wi-Fi AP signals), sensor information, or any combination thereof. According to some embodiments, a mobile device may have scheduled times at which it uses a priority list to determine the localization method used, and each scheduled time may be associated with a particular context/priority list. In such embodiments, contexts may correspond to scheduled times at which the mobile device performs localization. Returning to the previous example, for instance, a first context may correspond with scheduled times 1-10, a second context may correspond with scheduled times 11-20, and the third context may correspond with scheduled times 21-25, where the first, second, and third contexts correspond with times during which the mobile device is expected to be in respective first, second, and third segments of the journey. Again, the mobile device may use an alternative context in certain instances where, for example, an event is detected that is associated with a different context.

According to some embodiments, a set of priority lists may comprise a machine learning (ML) model, such as a trained neural network (NN) model, capable of implementing the functionality described above with respect to FIG. 3. For example, some embodiments may utilize a trained NN model (e.g., executed on the mobile device or a device communicatively coupled therewith) that may receive one or more contexts as input and output a location technology or the mobile device use. A mobile device may also provide a previously-used location technology to the NN model in order to receive a location technology on the NN model that is next in priority. Additionally or alternatively, an ML model may be capable of receiving one or more contexts as input and providing at least a portion of a prioritized list as an output. According to some embodiments, and ML model may be capable of generating a set of priority lists as described herein. In such embodiments, the ML model may be executed on a server or other device used to generate the set of priority lists I'm as described herein.

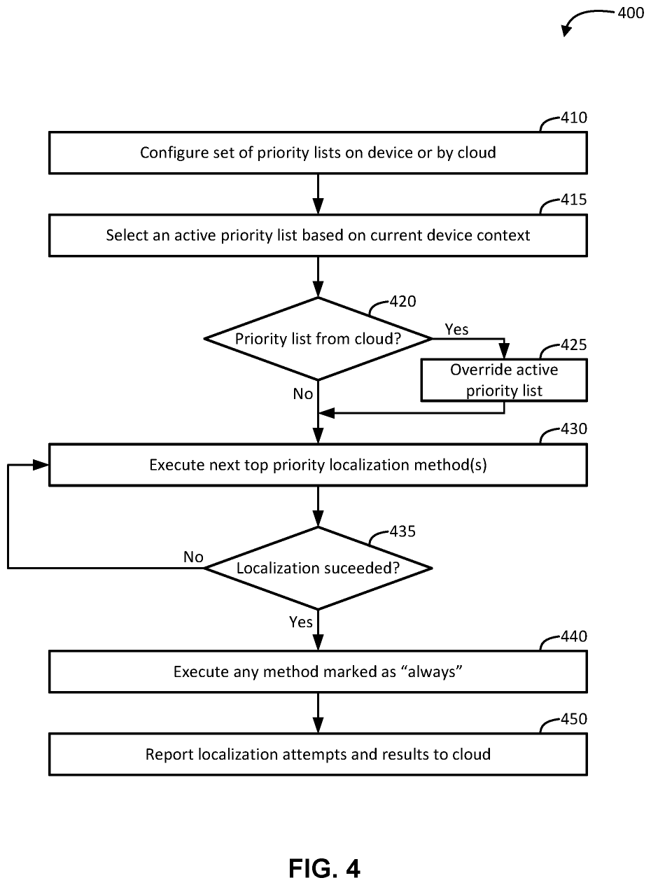

FIG. 4 is a flow diagram 400 of example functionality, related to the use of priority lists for determining a localization method, that a mobile device may employ during the course of the journey. In some aspects, this functionality may be seen as a way in which a mobile device may execute the functionality for using priority lists described above. As with other figures, FIG. 4 is provided as a nonlimiting example. In alternative embodiments may rearrange, combine, separate, omit, or otherwise alter some functions of the method to perform similar functionality. Further, in FIG. 4, the functionality of the “cloud” may be performed by one or more servers (e.g., journey server 150, application server 155, device server 157, or any combination thereof, from FIG. 1).

At block 410, the mobile device configures a set of priority lists of localization methods to use for a journey. This may be performed before or at the commencement of the journey, for example. Depending on desired functionality, this configuration may be performed at the mobile device (e.g., using a default or pre-existing set of priority lists on the mobile device) and/or by the cloud, the latter of which may provide the mobile device with a context-based set of priority lists based on the particular journey of the mobile device, as previously noted. The cloud may also provide the mobile device with contextual information related to certain detected events, as discussed above (e.g., if event X is detected, use priority list for context Y).

At block 415, the mobile device may later select a priority list based on current device context. This may be performed during the journey, based on certain detected events, a predetermined schedule, and/or other triggers. As described in more detail hereafter, some embodiments may enable a priority list to be retrieved from the cloud during the journey. In such embodiments, as indicated at blocks 420 and 425, any priority lists received from the cloud may override any active priority list on the mobile device. This can enable the mobile device to use a priority list that may have been generated by the cloud using relevant up-to-date information (e.g., traffic, weather, etc.).

The functionality at blocks 430-440 illustrate how the mobile device may use an applicable priority list. At block 430, the mobile device executes the next top priority localization method(s). This starts with the method(s) in the priority list entry having the highest priority, as previously described with respect to FIG. 3. At indicated by block 435, if localization does not succeed, the method then reverts back to block 430, where the next top priority localization method(s) (e.g., next entry in the priority list) can be executed. Otherwise, if the localization succeeds, the mobile device may then also execute any method designated as an “always” localization method (corresponding to entries in the table 300 of FIG. 3 having the “a” designation), as shown at block 440.

At block 450, the mobile device may then report localization attempts and results to the cloud. According to some embodiments, this may include reporting all localization attempts. This may be used by the cloud, for example, as part of historical information to determine the reliability of certain localization methods at certain points in a journey. Localization methods having less reliability at certain locations may be identified and de-prioritized in priority lists made for future travel through the certain locations, for instance.

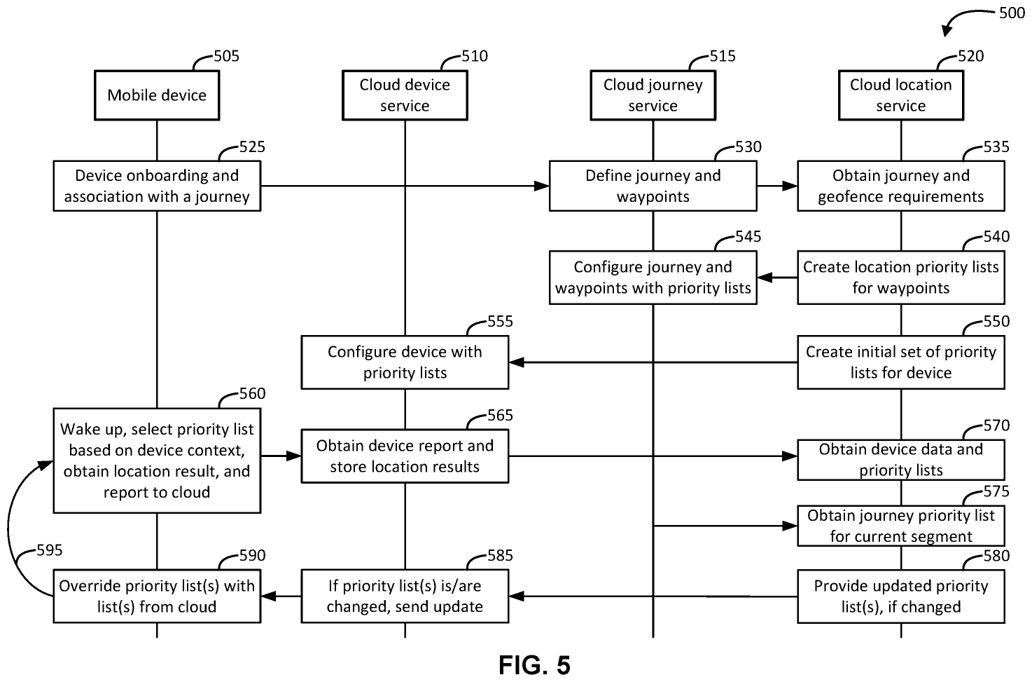

FIG. 5 is a call flow diagram 500 illustrating how a mobile device 505 may interact with cloud services to obtain and use priority lists for localization methods, according to some embodiments. As shown, cloud services may comprise cloud device service 510, cloud journey service 515, and cloud location service 520. These services may be respectively executed by a device server 157, journey server 150, and location server 155, as illustrated in FIG. 1.

At block 525, the mobile device 505 may undergo device onboarding in association with a journey. Generally, device onboarding may alert the cloud of the device and intended journey so that the cloud may track the mobile device 505 on the journey. Although not illustrated in FIG. 5, this may include the mobile device 505 providing the cloud (e.g., cloud location service 520) with information regarding the mobile device's capability for performing localization. Specifically, this may include an indication of the types of localization methods the mobile device may perform, as well as technical specifications for each (e.g., accuracy, power consumption, communication overhead, and/or the like).

As indicated at block 530, the cloud journey service 515 may define the journey for the mobile device, including waypoints. This may be implemented by the cloud journey service 515 using a rules-based approach for navigation, based on input from the mobile device 505 and/or a user (e.g., via a web portal, application, or other user interface (UI)), identifying the mobile device 505, origin, destination, waypoints, time of travel, and/or other travel related information, or any combination thereof. As indicated at block 535, this information may be provided to the cloud location service 520.

At block 540, the cloud location service 520 may create location priority lists for one or more waypoints of the journey. These priority lists may be based on the factors previously identified: device capabilities, historical information and/or predicted conditions at the various waypoints, etc. the cloud location service 520 may then provide the priority lists to the cloud journey service 515, which may configure the journey and waypoints with the priority lists, as shown at block 545. As an alternative (or in addition) to providing a mobile device with priority lists for different segments of the journey, associating priority lists with waypoints in the cloud in this manner may allow for the cloud to revisit and update the priority lists during the journey and then provided to the mobile device, as described hereafter.

At block 550, the cloud location service 520 determines a set of priority lists for the mobile device to use during the journey. As previously noted, this may be based on the capabilities of the device, known information regarding the journey (e.g., historical data on the reliability or yield of different localization methods at different locations of the journey), and/or other factors. As discussed hereafter, some embodiments may allow for priority lists to be updated during the journey, in which case the set of priority lists created at block 550 may comprise an initial set of priority lists. As previously described, a set of priority lists may comprise, for each of a plurality of contexts, and associated list of one or more localization methods, where entries on the list have a priority. Because the cloud device service 510 may be used to interface with the mobile device 505, the set of priority lists may be passed from the cloud location service 520 to the cloud device service 510. The cloud device service 510 may then configure the mobile device with the set of priority lists, as indicated at block 555.

At block 560, the mobile device 505, which may enter a “sleep” (low-power) mode during the journey when not performing localization or communicating with the cloud, may wake up in accordance with a predetermined schedule and/or interval to perform localization and report its location estimate to the cloud. It may perform localization based on a localization method determined using a priority list, which may be selected based on a context applicable to the mobile device (e.g., at the time the mobile device wakes up). It may then provide location results (and optionally other data, such as device status) the cloud device service 510, as indicated at block 565. In some embodiments, the mobile device 505 may also provide the cloud device service 510 with an indication of which priority list was used to determine its location estimate. At block 570, the cloud device service 510 shares device data and priority list information with the cloud location service 520.

The functionality at block 575-595 illustrate how priority lists used by a mobile device 505 for selecting a localization method may be updated during the course of a journey, according to some embodiments. At block 575, the cloud location service 520 obtains journey priority list information for a segment of the journey in which the mobile device 505 is traveling or will soon travel. This may be based, in part, on a location of the mobile device received at block 570. The priority list(s) for the segment may correspond with the priority lists created at block 540 and provided to the cloud journey service at block 545. The cloud location service 520 may then determine whether to update the priority list(s) obtained at block 575 based on current data (e.g., traffic data, weather data, etc.). Updates may be needed, for example, if current conditions at the segment of the journey do not match and predicted conditions of the segment when the initial set of priority lists were created (at block 550).

If one or more updated priority lists are created, the cloud location service 520 may provide the updated priority list(s) to the cloud device service 510, as indicated at blocks 580 and 585. The cloud device service 510 may then update the mobile device 505 with the updated priority list(s). Upon receiving an updated priority list from the cloud device service 510, the mobile device 505 may then override its current priority list(s) with corresponding updated priority list(s) from the cloud, as shown at block 590. As indicated at arrow 595, the process may then revert to block 560, where the mobile device 505 may use the updated priority list(s) for subsequent localization.

As previously noted, a mobile device may be capable of adjusting or altering a priority list at certain times, which may be based on current context. For example, a mobile device may adapt one or more priority lists when it has no stable connection with the cloud, when it identifies a need for an updated priority list (e.g., based on detecting one or more events that are not associated with a context in the current set of priority lists) without extra time delay or communication overhead with the cloud, when it lacks enough resources, such as bandwidth or power, to communicate with the cloud, or similar situations.

Despite this autonomy at the mobile device, the cloud may still have control of priority lists used by the mobile device, according to some embodiments. For example, as previously discussed regarding FIG. 5, the cloud may configure a new mobile device's set of priority lists, pre-configure a mobile device's priority lists when the mobile device's journey with one or more waypoints is defined, keep track of a mobile device's context and decide whether to update its priority list based on the context, override a mobile device's local priority lists, or the like.

A selection by a mobile device of which priority list in a priority list set to use may depend on various factors. One such factor is a device's current condition. Another factor may include user requirements, such as requirements of location for a journey and/or segments of the journey between two consecutive waypoints. Other factors may include technical specifications of each localization technology available to the mobile device, dynamic context of the device, journey, and surrounding environment. As previously noted with respect to FIG. 3, a priority list may be associated with a context. And thus, according to some embodiments, these different factors may be used to determine and applicable context to the mobile device, and an associated priority list.

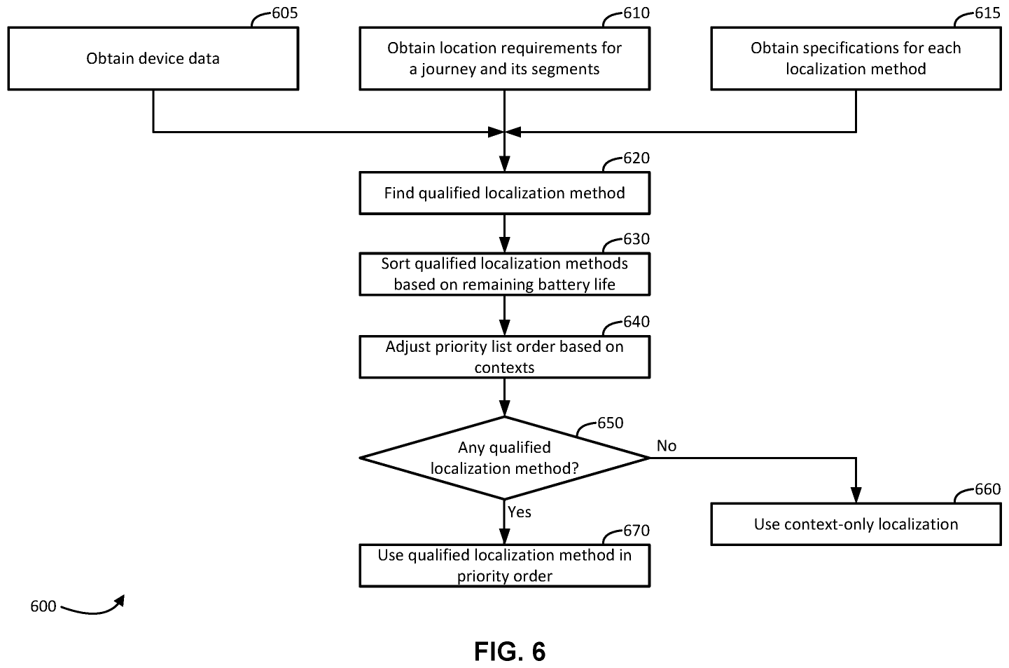

According to some embodiments, a mobile device may employ an algorithm that can be used to adjust a priority list based on context. An example of such an algorithm is illustrated in FIG. 6.

FIG. 6 is a flow diagram 600 of a method for adjusting a priority list, which may be based on context information specific to the mobile device. The functionality of the various blocks illustrated in FIG. 6 may be performed by one or more cloud services or a mobile device prior to a journey and/or at one or more points during the journey. A portion of the information obtained at blocks 605-615 (e.g., static information that does not change during the journey) may be obtained prior to the journey, stored by the cloud service(s) or a mobile device, and subsequently retrieved during the journey upon execution of subsequent operations of the method.

The functionality at block 605 comprises obtaining device data. This data may include, for example, battery level, technical capabilities (e.g., battery size, supported localization methods, air interfaces, and the like), device sensor information, or any combination thereof. For supported localization methods, this may further include a duty cycle for a device to wake up and report location.

The functionality at block 610 comprises obtaining location requirements for a journey and its segments. Generally put, location requirements may comprise parameters or restrictions on localization, which may be specific to a device, user, and/or application. According to some embodiments, location requirements may be based on user input. Specific requirements may include a maximum allowed location error, maximum communication overhead (e.g., per report), maximum travel time, or any combination thereof.

The functionality at block 615 comprises obtaining specifications for each localization method supported by the mobile device. This may include, for example, capabilities for each localization method with respect to accuracy, power consumption, communication overhead, or any combination thereof.

The cloud service(s) or mobile device can then use the information obtained at blocks 605, 610, and 615 to find a qualified localization method, as indicated at block 620. According to some embodiments, the qualified localization method may be specific to a current segment of the journey (e.g., a portion of the journey between two waypoints). Depending on desired functionality, the determination of whether a localization method qualifies may be based on factors such as battery life. For example, according to some embodiments, cloud service(s) or a mobile device may obtain an estimate of the mobile device's battery life at the end of the journey, then determine whether a localization method qualifies based on whether, if used, the mobile device will have battery life at the end of the journey.

The cloud service(s) or mobile device may then adjust priority lists in view of which localization methods qualified, as indicated by the functionality at blocks 630-670. That is, at block 630, qualified localization methods may be sorted (e.g., prioritized) based on remaining battery life, and, at block 640, the order of the resulting list may be adjusted based on contexts. (Techniques for doing so are described in more detail hereafter.) Block 650 performs a check of the adjusted list to ensure that qualified localization method is still on the list. If not, the method can use context-only localization, as indicated at block 660. Otherwise, the qualified localization methods can be used in order of priority, as shown at block 670.

With respect to adjusting a priority list based on context, either with a mobile device or with a server in the cloud (e.g., as shown in FIG. 6), embodiments may use one or more context-based operations to do so. One such context-based operation comprises detecting where a localization method fails and deprioritizing it in the priority list. This may comprise the mobile device detecting a failure (e.g., timeout) of a localization technique and recording the closest known location for future use. It may then deprioritize the localization technique for future journeys in the same area. For example, a mobile device may leverage points of interest (POIs) on a map, such as urban canyon, tunnel, or indoor locations, to detect locations with weak GNSS performance to deprioritize GNSS at those locations. The mobile device may also deprioritize GTP when a network connection is not stable

Another context-based operation that can be used to adjust a priority list may comprise detecting where a localization method works well and prioritizing it in the priority list. For example, a mobile device may experience increased GTP location accuracy when the density of cell towers and/or Wi-Fi APs increases and/or increased accuracy in Wi-Fi, Bluetooth Low Energy (BLE), or UWB-based localization techniques when the mobile device is indoors. These locations may be recorded, and the priority list used at these locations may be adjusted accordingly.

Another context-based operation that can be used to adjust the priority list may comprise leveraging derived data from the mobile device and its sensors. For example, a mobile device may detect movement using an IMU, camera, barometer, and/or other sensors, and adjust the priority list of localization methods based on a current speed and/or an estimated current location. Different methods may be more effective at different speeds and/or locations.

Additionally or alternatively, embodiments may employ yet other operations for adjusting a priority list. This can include adjusting the priority based on device capabilities, optimizing a priority list based on historical information/performance data (e.g., training machine learning models apply in future journeys), adjusting priority based on context-assisted location prediction, disqualifying a localization method (e.g., removing it from the priority list) for a certain time period when it is known not to work, or a combination thereof. Again, one or more of these operations may be performed in addition or as an alternative to the above-identified context-based operations for adjusting a priority list of localization methods.

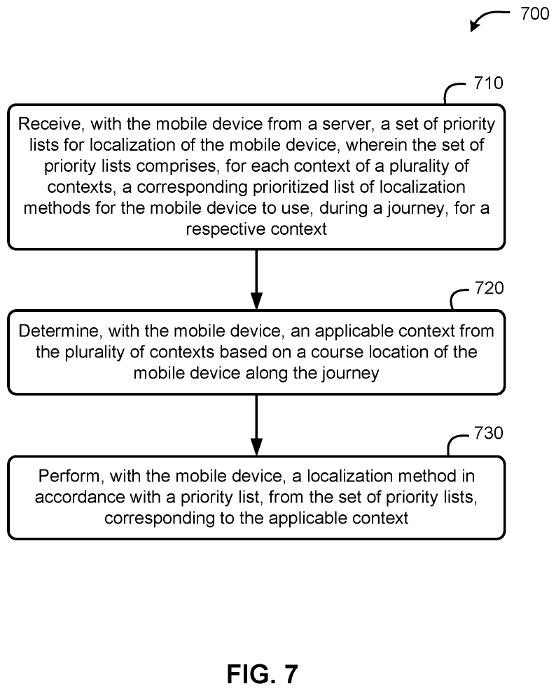

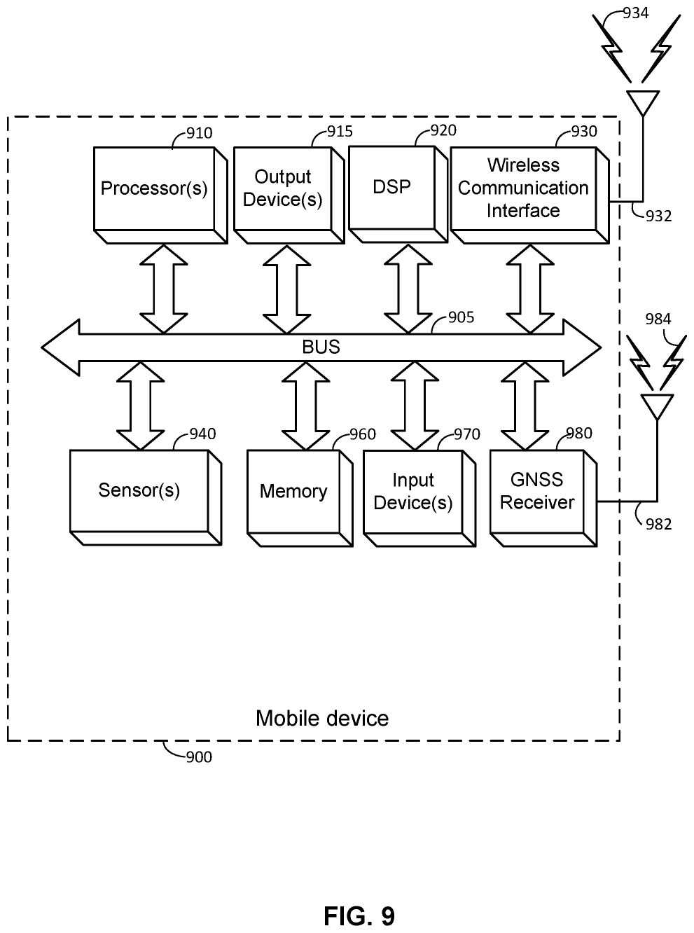

FIG. 7 is a flow diagram of a method 700 of localization of a mobile device, according to an embodiment. Means for performing the functionality illustrated in one or more of the blocks shown in FIG. 7 may be performed by hardware and/or software components of a mobile device. Example components of a mobile device are illustrated in FIG. 9, which is described in more detail below.

At block 710, the functionality comprises receiving, with the mobile device from a server, a set of priority lists for localization of the mobile device, wherein the set of priority lists comprises, for each context of a plurality of contexts, a corresponding prioritized list of localization methods for the mobile device to use, during a journey, for a respective context. Example set of priority lists is illustrated in FIG. 3, described above, although embodiments are not so limited. As noted, the contents of each list in the set of priority lists may include any of a variety of localization (e.g., positioning) methods. As such, in some embodiments of the method 700, the prioritized list of localization methods for at least one priority list of the set of priority lists comprises GNSS positioning, non-terrestrial communication network positioning (e.g., by NTN satellites and/or other NTN nodes), terrestrial cellular positioning, terrestrial Wi-Fi positioning, ultra-wideband (UWB) positioning, Bluetooth Low Energy (BLE)-based positioning, visual-based positioning (e.g., camera, VIO, etc.), sensor-assisted positioning, context-based positioning, or a combination thereof. According to some embodiments, the set of priority lists may be received by the mobile device prior to the mobile device embarking on the journey. Additionally or alternatively, some embodiments of the method 700 may comprise receiving, at the mobile device from the server, an indication for a context, of the plurality of contexts, for the mobile device to use for at least one portion of the journey. This may include, for example, a context/priority list to use during a certain segment or waypoint of the journey.

Means for performing functionality at block 710 may comprise a bus 905, one or more processors 910, a digital signal processor (DSP) 920, wireless communication interface 930, a memory 960, and/or other components of a mobile device, as illustrated in FIG. 9.

At block 720, the functionality comprises determining, with the mobile device, an applicable context from the plurality of contexts based on a course location of the mobile device along the journey. A course location may comprise an estimated or approximated location (e.g., waypoint, journey segment, etc.), which may be based on time, dead reckoning, etc. (which may not include use of a location technology on a priority list). According to some embodiments determining the applicable context occurs during the journey, and the applicable context is applicable to the mobile device at a point in time during the journey. As indicated in the embodiments described herein, this determination may be based on event detection by the mobile device (e.g., using sensor information, RF information, etc.) and/or information received at the mobile device from a server. Thus, according to some embodiments of the method 700, determining the applicable context from the plurality of contexts may comprise determining, with the mobile device, an event associated with the applicable context, determining the applicable context based on input received at the mobile device, or a combination thereof. In such embodiments, the input received at the mobile device may comprise a user input, information from the server, information from another device, or any combination thereof. In some embodiments, the input received at the mobile device may comprise real-time or near real-time information indicative of a congestion level of one or more radio frequencies used by one or more of the localization methods. In some embodiments, determining the event associated with the applicable context may be based at least in part on an indication, received from the server, of an association of the event with the applicable context.

Means for performing functionality at block 720 may comprise a bus 905, one or more processors 910, a digital signal processor (DSP) 920, wireless communication interface 930, one or more sensors 940, a memory 960, a GNSS receiver 980, and/or other components of a mobile device, as illustrated in FIG. 9.

At block 730, the functionality comprises performing, with the mobile device, a localization method in accordance with a priority list, from the set of priority lists, corresponding to the applicable context. Performance of a localization method in accordance with the priority list may comprise attempting a first localization method on the priority list and, if it fails, attempting the second localization method on the priority list, and so forth. As noted, a priority list may include one or more localization methods to use (e.g., in priority). Items on the list may also include a null entry and/or and “always use” localization method. As such, according to some embodiments of the method 700, the priority list corresponding to the applicable context may comprise at least a first localization method for the mobile device to use, a second localization method for the mobile device to use if the first localization method is unsuccessful, and a third localization method for the mobile device to always use for the applicable context.

Means for performing functionality at block 730 may comprise a bus 905, one or more processors 910, a digital signal processor (DSP) 920, wireless communication interface 930, one or more sensors 940, a memory 960, a GNSS receiver 980, and/or other components of a mobile device, as illustrated in FIG. 9.

As indicated in the embodiments described herein, some embodiments may include one or more operations, depending on desired functionality. For example, according to some embodiments, the method 700 may further comprise obtaining, with the mobile device, contextual information during the journey, sending, from the mobile device to the server, the contextual information, and subsequent to sending the contextual information, receiving, with the mobile device, one or more updated priority lists from the server. This can allow for a server to provide the updated priority lists based on live contextual information received from the mobile device. According to some embodiments, the mobile device may further determine a location estimate of the mobile device based on the performing of the localization method and 10, from the mobile device to a remote device, an indication of the location estimate. In some embodiments, the remote device the comprise the server. As also noted herein, a set of priority lists may be made based on information regarding a journey (waypoints, geo-fence requirements, etc.). Thus, some embodiments may further comprise sending, from the mobile device to the server, information regarding the journey, wherein sending the information regarding the journey occurs prior to receiving the set of priority lists. This can allow for server to base the set of priority lists on the journey information, which may be provided by a cloud journey service, or by the mobile device itself.

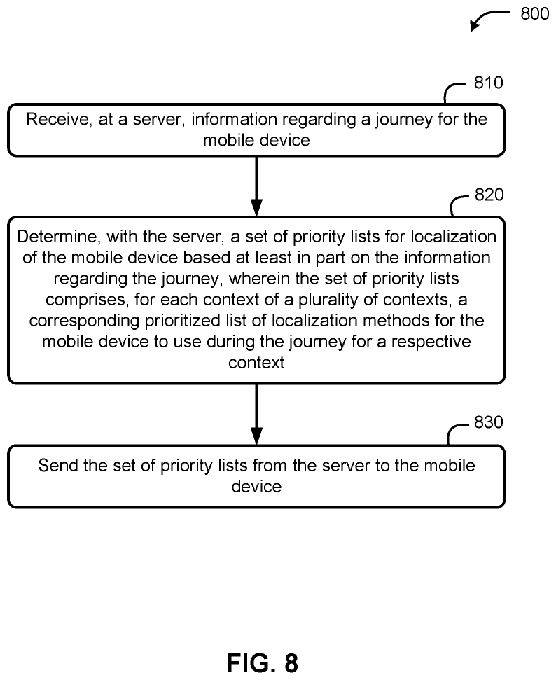

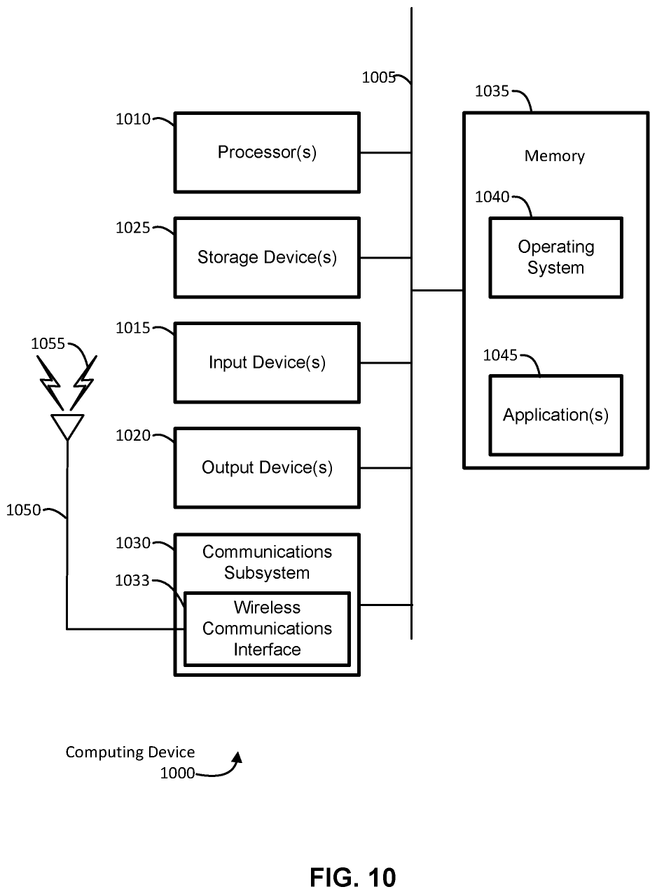

FIG. 8 is a flow diagram of a method 800 of localization of a mobile device, according to an embodiment. In some aspects, the functionality of the method 800 may show server-side functionality formed in conjunction with the mobile device-side functionality of the method 700 of FIG. 7. Means for performing the functionality illustrated in one or more of the blocks shown in FIG. 8 may be performed by hardware and/or software components of a computer system comprising server and/or executing a server application. Example components of a computer system are illustrated in FIG. 10, which is described in more detail below.

At block 810, the functionality comprises receiving at a server, information regarding a journey for the mobile device. As noted elsewhere herein, information regarding a journey of the mobile device may be provided by the mobile device itself or by a cloud journey service (e.g., as illustrated in FIG. 5) or equivalent. In some embodiments, the information regarding the journey may be indicative of one or more waypoints of an intended route of travel for the mobile device during the journey. Other embodiments may indicate journey information in different ways.

Means for performing functionality at block 810 may comprise a bus 1005, one or more processors 1010, one or more storage devices 1025, one or more input devices 1015, a communications subsystem 1030, a memory 1035 (which may include operating system 1040 and/or one or more applications 1045), and/or other components of a computer system, as illustrated in FIG. 10.

At block 820, the functionality comprises determining, with the server, a set of priority lists for localization of the mobile device based at least in part on the information regarding the journey, wherein the set of priority lists comprises, for each context of a plurality of contexts, a corresponding prioritized list of localization methods for the mobile device to use during the journey for a respective context. Depending on desired functionality, each list may be unique to a particular context. Further, the prioritized list of localization methods for at least one priority list of the set of priority lists may comprise a first localization method for the mobile device to use, a second localization method for the mobile device to use if the first localization method is unsuccessful, and a third localization method for the mobile device to always use. Again, a priority list may comprise null entries as well. To help ensure a mobile device uses a certain priority list during a certain portion of the journey, a server may associated context or event with that portion of the journey. As such, some embodiments of the method 800 may further comprise sending, to the mobile device from the server, an indication for a context, of the plurality of contexts, for the mobile device to use for at least one portion of the journey. Additionally or alternatively, some embodiments of the method 800 may comprise sending, from the server to the mobile device, an indication of an association of an event with at least one context of the plurality of contexts.

Means for performing functionality at block 820 may comprise a bus 1005, one or more processors 1010, one or more storage devices 1025, one or more input devices 1015, a communications subsystem 1030, a memory 1035 (which may include operating system 1040 and/or one or more applications 1045), and/or other components of a computer system, as illustrated in FIG. 10.

At block 830, the functionality comprises sending the set of priority lists from the server to the mobile device. Again, in some implementations, the server may send the set of priority lists to the mobile device before the mobile device embarks on the journey. That said, some embodiments may allow for the server to provide the initial priority list and/or updated priority lists after the mobile device embarks on the journey.

Means for performing functionality at block 830 may comprise a bus 1005, one or more processors 1010, one or more storage devices 1025, one or more input devices 1015, a communications subsystem 1030, a memory 1035 (which may include operating system 1040 and/or one or more applications 1045), and/or other components of a computer system, as illustrated in FIG. 10.

As indicated in the embodiments described herein, some embodiments may include one or more operations. For example, some embodiments may further comprise receiving, at the server from the mobile device, contextual information obtained by the mobile device during the journey, determining, with the server, one or more updated priority lists based at least in part on the contextual information, and sending the one or more updated priority lists from the server to the mobile device. According to some embodiments, the prioritized list of localization methods for at least one priority list of the set of priority lists may comprise GNSS positioning, terrestrial cellular positioning, terrestrial Wi-Fi positioning, sensor-assisted positioning, context-based positioning, or a combination thereof.

FIG. 9 is a block diagram of an embodiment of a mobile device 900, which can be utilized as described herein above (e.g., in association with the previously-described figures). For example, the mobile device 900 may be utilized as and/or correspond with mobile device(s) 105 or 505 in FIGS. 1 and 5. It should be noted that FIG. 9 is meant only to provide a generalized illustration of various components, any or all of which may be utilized as appropriate. Furthermore, the functionality of a UE discussed herein (e.g., a mobile device 105) may be executed by one or more of the hardware and/or software components illustrated in FIG. 9.

The mobile device 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The mobile device 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The mobile device 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile device 900 to communicate with other devices as described in the embodiments above. The wireless communication interface 930 may permit data and signaling to be communicated (e.g., transmitted and received) with transmission/reception points (TRPs) of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile device 900 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements for sensor-assisted positioning and/or other information (e.g., for determining an approximate location of a the mobile device 900, as described herein).

Embodiments of the mobile device 900 may also include a GNSS receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the mobile device 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 910 or DSP 920.

The mobile device 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the mobile device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the mobile device 900 (and/or processor(s) 910 or DSP 920 within mobile device 900). In some embodiments, then, such code and/or instructions can be used to configure and/or adapt a general-purpose computer (or other device) to perform one or more operations in accordance with the described methods.

FIG. 10 is a block diagram of an embodiment of a computer system 1000, which may be used, in whole or in part, to provide the functions of one or more components and/or devices as described in the embodiments herein, including a server and/or services in the cloud. Thus, the computer system 1000 may be utilized as and/or correspond with a journey server 150, location server 155, device server 157, monitoring device(s) 145, or any combination thereof, as described herein. This may include, for example, a computer server, personal computer, personal electronic device, or the like. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1000 is shown comprising hardware elements that can be electrically coupled via a bus 1005 (or may otherwise be in communication, as appropriate). The hardware elements may include processor(s) 1010, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1000 also may comprise one or more input devices 1015, which may comprise without limitation a mouse, a keyboard, a camera, a microphone, and/or the like; and one or more output devices 1020, which may comprise without limitation a display device, a printer, and/or the like.

The computer system 1000 may further include (and/or be in communication with) one or more non-transitory storage devices 1025, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1000 may also include a communications subsystem 1030, which may comprise wireless communication technologies managed and controlled by a wireless communication interface 1033, as well as wired technologies (such as Ethernet, coaxial communications, universal serial bus (USB), and the like). The wireless communication interface 1033 may comprise one or more wireless transceivers that may send and receive wireless signals 1055 (e.g., signals according to 5G NR or LTE) via wireless antenna(s) 1050. Thus the communications subsystem 1030 may comprise a modem, a network card (wireless or wired), an infrared communication device, a wireless communication device, and/or a chipset, and/or the like, which may enable the computer system 1000 to communicate on any or all of the communication networks described herein to any device on the respective network, including a User Equipment (UE), base stations and/or other transmission reception points (TRPs), and/or any other electronic devices described herein. Hence, the communications subsystem 1030 may be used to receive and send data as described in the embodiments herein.

In many embodiments, the computer system 1000 will further comprise a working memory 1035, which may comprise a RAM or ROM device, as described above. Software elements, shown as being located within the working memory 1035, may comprise an operating system 1040, device drivers, executable libraries, and/or other code, such as one or more applications 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of localization of a mobile device, the method comprising: receiving, with the mobile device from a server, a set of priority lists for localization of the mobile device, wherein the set of priority lists comprises, for each context of a plurality of contexts, a corresponding prioritized list of localization methods for the mobile device to use, during a journey, for a respective context; determining, with the mobile device, an applicable context from the plurality of contexts based on a course location of the mobile device along the journey; and, performing, with the mobile device, a localization method in accordance with a priority list, from the set of priority lists, corresponding to the applicable context.
Clause 2. The method of clause 1, wherein determining the applicable context from the plurality of contexts: determining, with the mobile device, an event associated with the applicable context, determining the applicable context based on input received at the mobile device, or a combination thereof.
Clause 3. The method of clause 2 wherein the input received at the mobile device comprises a user input, information from the server, information from another device, or any combination thereof.
Clause 4. The method of any one of clauses 2-3 the input received at the mobile device comprises real-time or near real-time information indicative of a congestion level of one or more radio frequencies used by one or more of the localization methods.
Clause 5. The method of any one of clauses 2-4 wherein determining the event associated with the applicable context is based at least in part on an indication, received from the server, of an association of the event with the applicable context.
Clause 6. The method of any one of clauses 1-5 wherein the priority list corresponding to the applicable context comprises at least: a first localization method for the mobile device to use, a second localization method for the mobile device to use if the first localization method is unsuccessful, and a third localization method for the mobile device to always use for the applicable context.
Clause 7. The method of any one of clauses 1-6 wherein the set of priority lists is received by the mobile device prior to the mobile device embarking on the journey.
Clause 8. The method of any one of clauses 1-7 further comprising receiving, at the mobile device from the server, an indication for a context, of the plurality of contexts, for the mobile device to use for at least one portion of the journey.
Clause 9. The method of any one of clauses 1-8 further comprising obtaining, with the mobile device, contextual information during the journey; sending, from the mobile device to the server, the contextual information; and subsequent to sending the contextual information, receiving, with the mobile device, one or more updated priority lists from the server.
Clause 10. The method of any one of clauses 1-9 further comprising determining, with the mobile device, a location estimate of the mobile device based on the performing of the localization method; and sending, from the mobile device to a remote device, an indication of the location estimate.
Clause 11. The method of clause 10 wherein the remote device comprises the server.
Clause 12. The method of any one of clauses 1-11 further comprising sending, from the mobile device to the server, information regarding the journey, wherein sending the information regarding the journey occurs prior to receiving the set of priority lists.
Clause 13. The method of any one of clauses 1-12 wherein the prioritized list of localization methods for at least one priority list of the set of priority lists comprises: global navigation satellite system (GNSS) positioning, non-terrestrial communication network positioning, terrestrial cellular positioning, terrestrial Wi-Fi positioning, ultra-wideband (UWB) positioning, Bluetooth Low Energy (BLE)-based positioning, visual-based positioning, sensor-assisted positioning, context-based positioning, or a combination thereof.
Clause 14. A method of localization of a mobile device, the method comprising: receiving, at a server, information regarding a journey for the mobile device; determining, with the server, a set of priority lists for localization of the mobile device based at least in part on the information regarding the journey, wherein the set of priority lists comprises, for each context of a plurality of contexts, a corresponding prioritized list of localization methods for the mobile device to use during the journey for a respective context; and sending the set of priority lists from the server to the mobile device.
Clause 15. The method of clause 14, wherein the information regarding the journey is indicative of one or more waypoints of an intended route of travel for the mobile device during the journey.
Clause 16. The method of any one of clauses 14-15 further comprising sending, from the server to the mobile device, an indication of an association of an event with at least one context of the plurality of contexts.
Clause 17. The method of any one of clauses 14-16 wherein the prioritized list of localization methods for at least one priority list of the set of priority lists comprises: a first localization method for the mobile device to use, a second localization method for the mobile device to use if the first localization method is unsuccessful, and a third localization method for the mobile device to always use.
Clause 18. The method of any one of clauses 14-17 wherein the server sends the set of priority lists to the mobile device before the mobile device embarks on the journey.
Clause 19. The method of any one of clauses 14-18 further comprising sending, to the mobile device from the server, an indication for a context, of the plurality of contexts, for the mobile device to use for at least one portion of the journey.
Clause 20. The method of any one of clauses 14-19 further comprising receiving, at the server from the mobile device, contextual information obtained by the mobile device during the journey; determining, with the server, one or more updated priority lists based at least in part on the contextual information; and sending the one or more updated priority lists from the server to the mobile device.
Clause 21. The method of any one of clauses 14-20 wherein the prioritized list of localization methods for at least one priority list of the set of priority lists comprises: global navigation satellite system (GNSS) positioning, terrestrial cellular positioning, terrestrial Wi-Fi positioning, sensor-assisted positioning, context-based positioning, or a combination thereof.
Clause 22. A mobile device comprising: a transceiver; a memory; and one or more processors communicatively coupled with the transceiver and the memory, wherein the one or more processors are configured to: receive, via the transceiver from a server, a set of priority lists for localization of the mobile device, wherein the set of priority lists comprises, for each context of a plurality of contexts, a corresponding prioritized list of localization methods for the mobile device to use, during a journey, for a respective context; determine an applicable context from the plurality of contexts based on a course location of the mobile device along the journey; and perform a localization method in accordance with a priority list, from the set of priority lists, corresponding to the applicable context.
Clause 23. The mobile device of clause 22, wherein, to determine the applicable context from the plurality of contexts, the one or more processors are configured to: determine an event associated with the applicable context, determine the applicable context based on input from the server or another device, or a combination thereof.
Clause 24. The mobile device of any one of clauses 22-23 wherein the one or more processors are configured to base in determining the event associated with the applicable context at least in part on an indication, received via the transceiver from the server, of an association of the event with the applicable context.
Clause 25. The mobile device of any one of clauses 22-24 wherein the one or more processors are further configured to receive, via the transceiver from the server, an indication for a context, of the plurality of contexts, for the mobile device to use for at least one portion of the journey.
Clause 26. The mobile device of any one of clauses 22-25 wherein the one or more processors are further configured to: obtain contextual information during the journey; send, via the transceiver to the server, the contextual information; and subsequent to sending the contextual information, receive, via the transceiver, one or more updated priority lists from the server.
Clause 27. The mobile device of any one of clauses 22-26 wherein the one or more processors are further configured to: determine a location estimate of the mobile device based on the performing of the localization method; and send, via the transceiver to a remote device, an indication of the location estimate.
Clause 28. A server comprising: a transceiver; a memory; and one or more processors communicatively coupled with the transceiver and the memory, wherein the one or more processors are configured to: receive information regarding a journey for a mobile device; determine a set of priority lists for localization of the mobile device based at least in part on the information regarding the journey, wherein the set of priority lists comprises, for each context of a plurality of contexts, a corresponding prioritized list of localization methods for the mobile device to use during the journey for a respective context; and send the set of priority lists from the server to the mobile device via the transceiver.
Clause 29. The server of clause 28, wherein the one or more processors are further configured to send, via the transceiver to the mobile device, an indication of an association of an event with at least one context of the plurality of contexts.
Clause 30. The server of any one of clauses 28-29 wherein the one or more processors are configured to include, in the prioritized list of localization methods for at least one priority list of the set of priority lists: a first localization method for the mobile device to use, a second localization method for the mobile device to use if the first localization method is unsuccessful, and a third localization method for the mobile device to always use.
Clause 31. The server of any one of clauses 28-30 wherein the one or more processors are further configured to send, to the mobile device via the transceiver, an indication for a context, of the plurality of contexts, for the mobile device to use for at least one portion of the journey.
Clause 32. The server of any one of clauses 28-31 wherein the one or more processors are further configured to: receive, via the transceiver from the mobile device, contextual information obtained by the mobile device during the journey; determine one or more updated priority lists based at least in part on the contextual information; and send the one or more updated priority lists from the server to the mobile device via the transceiver.
Clause 33. An apparatus having means for performing the method of any one of clauses 1-21.
Clause 34. A non-transitory computer-readable medium storing instructions, the instructions comprising code for performing the method of any one of clauses 1-21.

What is claimed is:

1. A method of localization of a mobile device, the method comprising:
receiving, with the mobile device from a server, a set of priority lists for localization of the mobile device, wherein the set of priority lists comprises, for each context of a plurality of contexts, a corresponding prioritized list of localization methods for the mobile device to use, during a journey, for a respective context;
determining, with the mobile device, an applicable context from the plurality of contexts based on a course location of the mobile device along the journey; and
performing, with the mobile device, a localization method in accordance with a priority list, from the set of priority lists, corresponding to the applicable context.

2. The method of claim 1, wherein determining the applicable context from the plurality of contexts:
determining, with the mobile device, an event associated with the applicable context,
determining the applicable context based on input received at the mobile device, or
a combination thereof.

3. The method of claim 2, wherein the input received at the mobile device comprises a user input, information from the server, information from another device, or any combination thereof.

4. The method of claim 2, the input received at the mobile device comprises real-time or near real-time information indicative of a congestion level of one or more radio frequencies used by one or more of the localization methods.

5. The method of claim 2, wherein determining the event associated with the applicable context is based at least in part on an indication, received from the server, of an association of the event with the applicable context.

6. The method of claim 1, wherein the priority list corresponding to the applicable context comprises at least:
a first localization method for the mobile device to use,
a second localization method for the mobile device to use if the first localization method is unsuccessful, and
a third localization method for the mobile device to always use for the applicable context.

7. The method of claim 1, wherein the set of priority lists is received by the mobile device prior to the mobile device embarking on the journey.

8. The method of claim 1, further comprising receiving, at the mobile device from the server, an indication for a context, of the plurality of contexts, for the mobile device to use for at least one portion of the journey.

9. The method of claim 1, further comprising:
obtaining, with the mobile device, contextual information during the journey;
sending, from the mobile device to the server, the contextual information; and
subsequent to sending the contextual information, receiving, with the mobile device, one or more updated priority lists from the server.

10. The method of claim 1, further comprising:
determining, with the mobile device, a location estimate of the mobile device based on the performing of the localization method; and
sending, from the mobile device to a remote device, an indication of the location estimate.

11. The method of claim 10, wherein the remote device comprises the server.

12. The method of claim 1, further comprising sending, from the mobile device to the server, information regarding the journey, wherein sending the information regarding the journey occurs prior to receiving the set of priority lists.

13. The method of claim 1, wherein the prioritized list of localization methods for at least one priority list of the set of priority lists comprises:
global navigation satellite system (GNSS) positioning,
non-terrestrial communication network positioning,
terrestrial cellular positioning,
terrestrial Wi-Fi positioning,
ultra-wideband (UWB) positioning,
Bluetooth Low Energy (BLE)-based positioning,
visual-based positioning,
sensor-assisted positioning,
context-based positioning, or
a combination thereof.

14. A method of localization of a mobile device, the method comprising:
receiving, at a server, information regarding a journey for the mobile device;
determining, with the server, a set of priority lists for localization of the mobile device based at least in part on the information regarding the journey, wherein the set of priority lists comprises, for each context of a plurality of contexts, a corresponding prioritized list of localization methods for the mobile device to use during the journey for a respective context; and
sending the set of priority lists from the server to the mobile device.

15. The method of claim 14, wherein the information regarding the journey is indicative of one or more waypoints of an intended route of travel for the mobile device during the journey.

16. The method of claim 14, further comprising sending, from the server to the mobile device, an indication of an association of an event with at least one context of the plurality of contexts.

17. The method of claim 14, wherein the prioritized list of localization methods for at least one priority list of the set of priority lists comprises:
a first localization method for the mobile device to use,
a second localization method for the mobile device to use if the first localization method is unsuccessful, and
a third localization method for the mobile device to always use.

18. The method of claim 14, wherein the server sends the set of priority lists to the mobile device before the mobile device embarks on the journey.

19. The method of claim 14, further comprising sending, to the mobile device from the server, an indication for a context, of the plurality of contexts, for the mobile device to use for at least one portion of the journey.

20. The method of claim 14, further comprising:
receiving, at the server from the mobile device, contextual information obtained by the mobile device during the journey;
determining, with the server, one or more updated priority lists based at least in part on the contextual information; and
sending the one or more updated priority lists from the server to the mobile device.

21. The method of claim 14, wherein the prioritized list of localization methods for at least one priority list of the set of priority lists comprises:
global navigation satellite system (GNSS) positioning,
terrestrial cellular positioning,
terrestrial Wi-Fi positioning,
sensor-assisted positioning,
context-based positioning, or
a combination thereof.

22. A mobile device comprising:
a transceiver;
a memory; and
one or more processors communicatively coupled with the transceiver and the memory, wherein the one or more processors are configured to:
receive, via the transceiver from a server, a set of priority lists for localization of the mobile device, wherein the set of priority lists comprises, for each context of a plurality of contexts, a corresponding prioritized list of localization methods for the mobile device to use, during a journey, for a respective context;
determine an applicable context from the plurality of contexts based on a course location of the mobile device along the journey; and
perform a localization method in accordance with a priority list, from the set of priority lists, corresponding to the applicable context.

23. The mobile device of claim 22, wherein, to determine the applicable context from the plurality of contexts, the one or more processors are configured to:
determine an event associated with the applicable context,
determine the applicable context based on input from the server or another device, or
a combination thereof.

24. The mobile device of claim 23, wherein the one or more processors are configured to base in determining the event associated with the applicable context at least in part on an indication, received via the transceiver from the server, of an association of the event with the applicable context.

25. The mobile device of claim 22, wherein the one or more processors are further configured to receive, via the transceiver from the server, an indication for a context, of the plurality of contexts, for the mobile device to use for at least one portion of the journey.

26. The mobile device of claim 22, wherein the one or more processors are further configured to:
obtain contextual information during the journey;
send, via the transceiver to the server, the contextual information; and
subsequent to sending the contextual information, receive, via the transceiver, one or more updated priority lists from the server.

27. The mobile device of claim 22, wherein the one or more processors are further configured to:
determine a location estimate of the mobile device based on the performing of the localization method; and
send, via the transceiver to a remote device, an indication of the location estimate.

28. A server comprising:
a transceiver;
a memory; and
one or more processors communicatively coupled with the transceiver and the memory, wherein the one or more processors are configured to:
receive information regarding a journey for a mobile device;
determine a set of priority lists for localization of the mobile device based at least in part on the information regarding the journey, wherein the set of priority lists comprises, for each context of a plurality of contexts, a corresponding prioritized list of localization methods for the mobile device to use during the journey for a respective context; and
send the set of priority lists from the server to the mobile device via the transceiver.

29. The server of claim 28, wherein the one or more processors are further configured to send, via the transceiver to the mobile device, an indication of an association of an event with at least one context of the plurality of contexts.

30. The server of claim 28, wherein the one or more processors are configured to include, in the prioritized list of localization methods for at least one priority list of the set of priority lists:
a first localization method for the mobile device to use,
a second localization method for the mobile device to use if the first localization method is unsuccessful, and
a third localization method for the mobile device to always use.

31. The server of claim 28, wherein the one or more processors are further configured to send, to the mobile device via the transceiver, an indication for a context, of the plurality of contexts, for the mobile device to use for at least one portion of the journey.

32. The server of claim 28, wherein the one or more processors are further configured to:
receive, via the transceiver from the mobile device, contextual information obtained by the mobile device during the journey;
determine one or more updated priority lists based at least in part on the contextual information; and
send the one or more updated priority lists from the server to the mobile device via the transceiver.
